(19) United States
(12) Patent Application Publication
(10) Pub. No.: US 2014/0040573 A1
(43) Pub. Date: Feb. 6, 2014

(54) DETERMINING A NUMBER OF STORAGE DEVICES TO BACKUP OBJECTS IN VIEW OF QUALITY OF SERVICE CONSIDERATIONS

(71) Applicants: Ludmila Cherkasova, Sunnyvale, CA (US); Bernhard Kappler, Herrenberg (DE)

(72) Inventors: Ludmila Cherkasova, Sunnyvale, CA (US); Bernhard Kappler, Herrenberg (DE)

(21) Appl. No.: 13/563,153

(22) Filed: Jul. 31, 2012

(51) Int. Cl. G06F 12/16

(52) U.S. Cl. 711/162; 711/E12.103

(57) ABSTRACT

Storage device libraries, machine readable media, and methods are provided for determining a number of storage devices to backup objects in view of quality of service considerations. An example of a storage device library that determines the number of storage devices to backup objects includes a plurality of storage devices and a controller to control backup of the objects to an assigned number of the storage devices. The controller determines the assigned number of the storage devices before the backup of the objects based upon assigned parameters for backup of the objects that include a time window and a number of concurrent disk agents per storage device.

### BACKGROUND

Unstructured data is a large and fast growing portion of assets for companies and often represents 70% to 80% of online data. Analyzing and managing this unstructured data is a high priority for many companies. Further, as companies implement enterprise-wide content management, such as information classification and enterprise search, and as the volume of data in the enterprises continues to increase, establishing a data management strategy becomes more challenging. Backup systems process increasing amounts of data while having to meet time constraints of backup windows.

### BRIEF DESCRIPTION OF THE DRAWINGS

FIG. 1 illustrates an example of a storage system with a storage device library backing up objects according to the present disclosure.

FIGS. 2A-2B illustrate examples of graphs of backup profiles of objects in a defined set.

FIG. 3 illustrates an example of pseudo-code for an Enhanced FlexLBF process according to the present disclosure.

FIGS. 4A-4C illustrate other examples of graphs of backup profiles of objects in a defined set.

FIG. 5 illustrates an example of inputs and outputs to a simulator according to the present disclosure.

FIG. 6 illustrates an example of a flow diagram to determine a number of storage devices to backup objects according to the present disclosure.

FIG. 7 illustrates an example of a storage system according to the present disclosure.

### DETAILED DESCRIPTION

Examples presented herein relate to backup of data from one or more client machines (e.g., computers, servers, etc.) upon which the data is initially stored to storage devices, the backups to these storage devices being performed by using multiple concurrent processes termed disk agents (DAs) herein. An example analyzes historic data on previous backup processing from backup client machines and uses metrics (e.g., job duration and job throughput) to reduce an overall completion time for a given set of backup jobs. A job scheduling process termed FlexLBF can utilize extracted information from the historic data to provide a reduction in the backup time (e.g., by 50%) and reduce resource usage (e.g., by 2-3 times), among other benefits. Using this scheduling, the backup jobs with the longest duration are scheduled first, and a number of the jobs is processed concurrently by the DAs. The framework can reduce error-prone manual processes, for example, contributed by manual configuration and parameter tuning efforts by system administrators.

Various examples track and store metadata for multiple backup periods. This metadata provides data points for deriving metadata analysis and trending. For each backed up object (e.g., representing a mount point or a filesystem), there is recorded information on the number of processed files that includes, for example, the total number of transferred bytes and the elapsed backup processing time from previous backups. This information, in addition to other information described herein, can be used to increase efficiencies in backup of data and to improve run-time performance of future backups.

Some backup tools have a configuration parameter that defines a level of concurrency having a fixed number of concurrent DAs that can backup different objects in parallel to the storage devices (e.g., tape drives). This is done because a single data stream generated by a DA often does not fully utilize the capacity/bandwidth of the backup storage device due to slower uploading from client machines on which the objects were initially stored. As such, system administrators can perform and/or have a program perform a set of tests to determine a correct value of this parameter in their environment. This value can depend on both the available network bandwidth and the input/output (I/O) throughput of the client machines, among other considerations. Moreover, when configuring the backup tool, a system administrator can consider increasing a backup storage device throughput by enabling a higher number of concurrent DAs and/or reducing a data restore time by avoiding excessive data interleaving (e.g., by limiting the number of concurrent DAs). It may be difficult to select a fixed number of DAs for achieving both goals. Moreover, random job backup scheduling also may pose a potential problem for backup tools. In addition, when a set (e.g., one or more) of objects is scheduled for backup, it may be difficult to define a sequence or an order in which these objects should be processed by a backup tool. If a large and/or slow throughput object with a long duration backup time is selected significantly later in the backup session, this can lead to an inefficient schedule and/or an increased overall backup time, as described herein.

Examples, as described herein, utilize metrics such as job duration and job throughput to characterize the time duration to complete a backup job and the average throughput (MB/s) of this backup job during a number of backup sessions. In some environments, including those with multiple backup servers, job duration and throughput for multiple backup jobs for the same object are relatively stable over time. Therefore, this historic information can be used for more efficient backup scheduling in order to reduce the overall backup completion time in future backups. This problem can be formulated as a resource constrained scheduling problem where a set of N objects (e.g., jobs) are scheduled on M machines with given capacities. Each object (e.g., job J) can be defined by a pair of attributes (e.g., height, width) that correspond to job duration and throughput, respectively. At any time, each machine can process an arbitrary number of jobs in parallel but the total width of these jobs may not exceed the throughput capacity of the storage device.

With the FlexLBF process, the longest backups are scheduled first and a flexible number of concurrent jobs are processed over time. By using the observed average throughput per object from the past measurements and the data rates that can be processed by the storage devices (e.g., the tape drives), example implementations can vary the number of concurrent objects assigned per storage device during a backup session in order to improve both the overall backup time and the storage device utilization during the backup session.

As described herein, backup sessions can be assigned to a particular time window (e.g., outside of regular business hours and/or at night, in one hour blocks fit in any time, among many other possibilities) and can be performed using an assigned number of concurrent DAs per storage device based upon quality of service (QoS) considerations. Among the QoS considerations is determining a number of storage devices upon which to backup a set (e.g., one or more) of objects. The number of storage devices upon which the set of objects are stored is a QoS consideration because, for example, restore rates for objects have empirically been shown to depend upon the number of concurrent DAs operating to backup the data (e.g., due to interleaving of the data of the storage device) and/or the number of storage devices upon which the data is saved, as has been documented in digital reference tables, as described herein. Hence, it would be preferential, if possible, to backup each object using a single DA on a single storage device, (e.g., a single tape drive). However, due to time and financial considerations, among others, backup of a set of objects concurrently may involve concurrent operation of a plurality of DAs saving the data to a plurality of storage devices. Nonetheless, as described herein, lowering the number of storage devices utilized to backup the set of objects increases QoS, along with performance of the same during a desired time window.

Hence, storage device libraries, machine readable media, and methods are provided for determining a number of storage devices to backup objects in view of QoS considerations (e.g., utilizing an Enhanced FlexLBF process). An example of a storage device library that determines the number of storage devices to backup objects includes a plurality of storage devices and a controller to control backup of the objects to an assigned number of the storage devices. The controller determines the assigned number of the storage devices before the backup of the objects based upon assigned parameters for backup of the objects that include a time window and a number of concurrent DAs per storage device.

In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, and/or structural changes may be made without departing from the scope of the present disclosure. Further, where appropriate, as used herein, “for example’ and “by way of example” should be understood as abbreviations for “by way of example and not by way of limitation”. In addition, the proportion and the relative scale of the elements provided in the figures are intended to illustrate the examples of the present disclosure and should not be taken in a limiting sense.

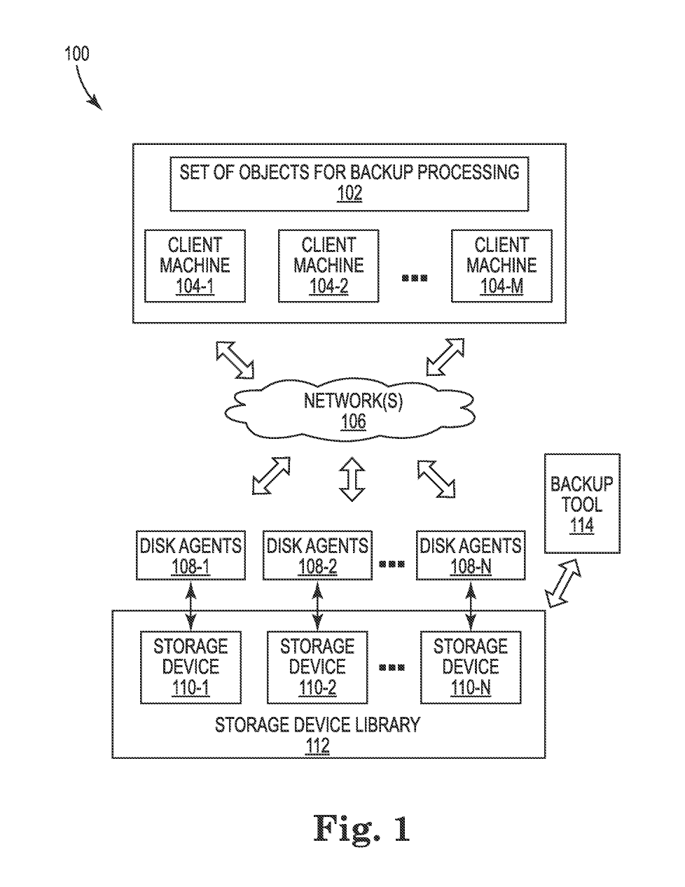

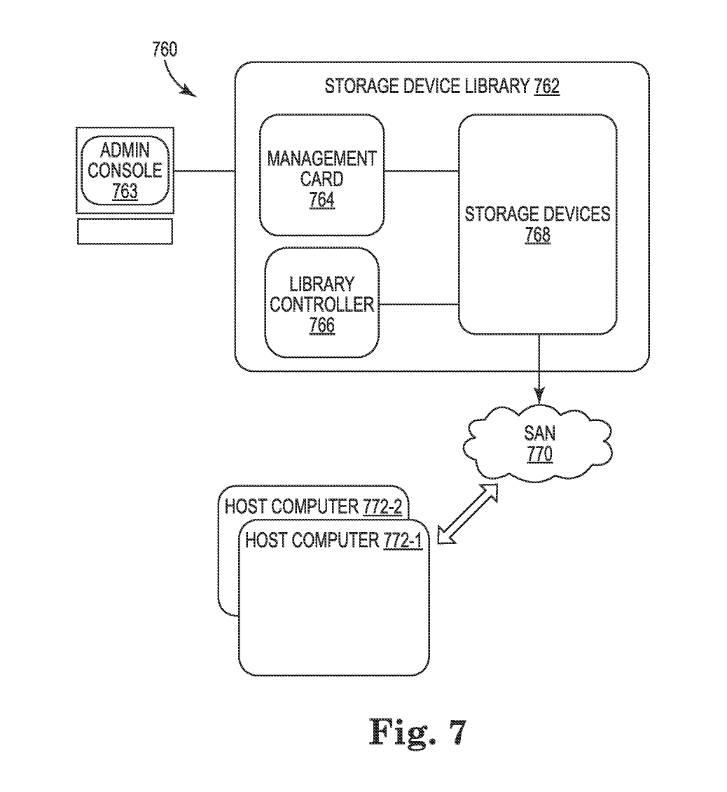

FIG. 1 illustrates an example of a storage system with a storage device library backing up objects according to the present disclosure. Functionality of a backup tool 114 can be built around a backup session (e.g., occurrence of active backup) and the objects (e.g., mount points or filesystems of the client machines) that are backed up during the session. FIG. 1 shows a storage system 100 that includes storage device (e.g., tape) library 112 using the backup tool 114 and/or software application. The library backs up a set of objects (e.g., filesystems) 102 to storage devices, such as storage devices (e.g., tape drives) 110-1, 110-2, through 110-N, using multiple DAs, such as 108-1, 108-2, through 108-N. The backup tool 114 manages the backup of the objects to the storage devices (e.g., as directed by a controller, as shown at 766 in FIG. 7). A plurality of client machines, hosts, and/or servers, such as 104-1, 104-2, through 104-M, can communicate with the storage device library 112 through a number of networks 106.

For example, there can be 4 to 6 storage devices, and each such storage device can have a configuration parameter that defines a concurrency level of DAs that backup different objects in parallel to the storage devices. To improve the total backup throughput, a system administrator may, for example, configure up to 32 DAs for each storage device to enable concurrent data streams from different objects at the same time. A drawback of such an approach is that the data streams from 32 different objects may be interleaved on the storage device (e.g., tape). When the data of a particular object is requested to be restored, there may be a higher restoration time for retrieving such data compared with a continuous, non-interleaved data stream written by a single DA.

When a defined set of one or more objects is assigned to be processed by the backup tool, a sequence or order may not have been defined in which these objects are to be processed by the tool. In such a situation, any available DA may be assigned for processing to any object from the set, and the objects, which might represent different mount points of the same client machine, may be written to different storage devices. Thus, an order has not been defined in which the objects are to be processed by concurrent DAs to the different storage devices. Potentially, this may lead to inefficient backup processing and an increased backup time.

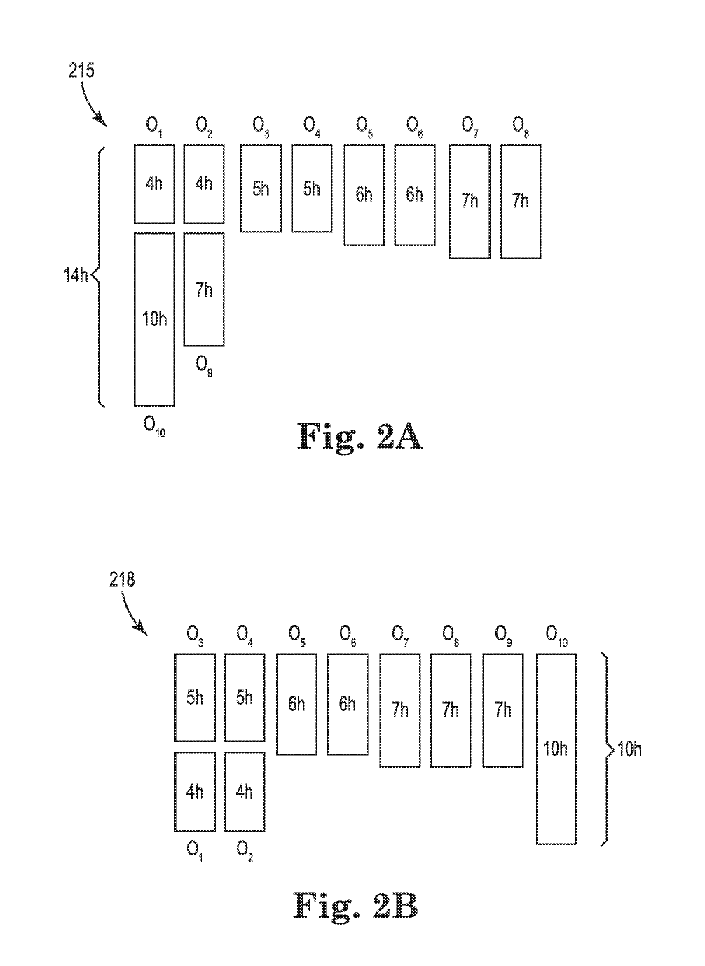

FIGS. 2A-2B illustrate examples of graphs of a backup profiles of objects. FIG. 2A illustrates an example of a graph of a backup profile of objects in accordance with the present disclosure. FIG. 2A shows blocks of backup times 215 for objects with random scheduling in accordance with this example. That is, the following example illustrates inefficiency of random assignment to DAs. Let there be ten objects O₁, O₂, . . . , O₁₀, in a backup set, and let the backup tool have four storage devices each configured with 2 concurrent DAs (e.g., with eight DAs in the system). Let these objects take approximately the following times for their backup processing: T₁=T₂=4 hours, T₃=T₄=5 hours, T₅=T₆=6 hours, T₇=T₈=T₉=7 hours, and T₁₀=10 hours. If the DAs randomly select the following eight objects, O₁, O₂, O₃, . . . , O₇, O₈, for initial backup processing, then objects O₉ and O₁₀ will be processed after the backup of O₁ and O₂ are completed (since backup of O₁ and O₂ take the shortest time of 4 hours), and the DAs which became available will then process O₉ and O₁₀. In this case, the overall backup time for the entire group will be 14 hours.

FIG. 2B illustrates an example of a graph of a backup profile of the objects in FIG. 2A according to the present disclosure. FIG. 2B shows blocks of backup times 218 for objects with improved scheduling using FlexLBF. The improved scheduling for this group is to process the ten objects shown in FIG. 2A instead as follows: O₃, O₄, . . . , O₁₀ first, and when processing of O₃ and O₄ is completed after 5 hours, the corresponding DAs will backup the remaining objects O₁ and O₂. If the object processing follows this new ordering schema then the overall backup time is 10 hours for the entire group. Thus, a total backup time of 4 hours is saved relative to the 14 shown in FIG. 2A.

When configuring a backup tool, a system administrator may attempt to improve the backup throughput by enabling a higher number of concurrent DAs while at the same time improving the data restore time by avoiding excessive data interleaving (e.g., by limiting the number of concurrent DAs). In other words, on one hand, a system administrator determines the number of concurrent DAs that are able to utilize the capacity/bandwidth of the backup storage device. On the other hand, the system administrator should not over-estimate the required number of concurrent DAs because the data streams from these concurrent agents are interleaved on the storage device. When the data of a particular object is restored there is a higher restoration time for retrieving such data compared with a continuous, non-interleaved data stream written by a single DA. Moreover, when the aggregate throughput of concurrent streams exceeds the specified storage device throughput, it may increase the overall backup time instead of decreasing it. Often the backup time of a large object dominates the overall backup time. Too many concurrent data streams (e.g., written at the same time) to the storage device decreases the effective throughput of each stream and, therefore, unintentionally increases the backup time of large objects and results in the overall backup time increase.

Accordingly, the FlexLBF process can adaptively change the number of active DAs at each storage device during the backup session to both improve the system throughput and decrease the backup time. With regard to the FlexLBF process, consider a backup tool with M storage devices (e.g., tapes): StorageDevice₁, . . . , StorageDeviceₘ. In contrast to previous systems that have a configuration parameter that defines a fixed concurrency DA number that can backup different objects in parallel to the storage devices, the FlexLBF process utilizes a variable number of concurrent DAs defined by the following parameters:
maxDA—a limit on an upper number of concurrent DAs that can be assigned per storage device (different limits may be used for different storage devices); and
maxTput—an aggregate throughput capability of the storage device (each storage device library is homogeneous, but there could be different generation tape libraries in an overall set).

The following running counters are utilized per storage device:
ActDAⱼ—a number of active (busy) DAs of StorageDeviceⱼ (initialized as ActDAⱼ=0); and
StorageDeviceAggTputⱼ—an aggregate throughput of the currently assigned objects (jobs) to StorageDeviceⱼ (initialized as StorageDeviceAggTputⱼ=0).

Each job J, in a future backup session can be represented by a tuple: (Oᵢ, Durᵢ, Tputᵢ), where:
Oᵢ is a name of the object;
Durᵢ denotes the backup duration of object Oᵢ observed from the previous full backup; and
Tputᵢ denotes the throughput of object Oᵢ computed as a mean of a last specified number of throughput measurements. Using a mean value of a plurality of throughput measurements provides a more reliable metric and reduces variance compared to a throughput metric computed from only the latest backup even with significant diversity in observed job throughputs (e.g., from 0.1 MB/s to 35 MB/s).

Based upon the historic information about all the objects (e.g., Durᵢ and Tputᵢ), an ordered list of objects OrdObjList sorted in decreasing order of their backup durations is created:

OrdObjList={(O₁, Dur₁, Tput₁), . . . , (Oₙ, Durₙ, Tputₙ)}, where Dur₁≧Dur₂≧Dur₃≧ . . . ≧Durₙ.

The FlexLBF scheduler operates as follows:

Let Jᵢ=(Oᵢ, Durᵢ, Tputᵢ) be the object having the longest previous backup time in OrdObjList. Let StorageDeviceⱼ have an available DA and

StorageDeviceAggTputⱼ=min (StorageDeviceAggTputᵢ), ActDAi<maxDA

where StorageDeviceⱼ is among the storage devices with an available DA, and StorageDeviceⱼ has the smallest aggregate throughput. Object Jᵢ is assigned to StorageDeviceᵢ if its assignment does not violate the maximum aggregate throughput specified per storage device, i.e., if the following condition is true:

StorageDeviceAggTputⱼ+Tputᵢ≦maxTput.

If this condition is satisfied, then object Oᵢ is assigned to StorageDeviceᵢ, and the storage device running counters are updated as follows:

ActDAⱼ<=ActDAⱼ+1,

StorageDeviceAggTputⱼ<=StorageDeviceAggTputⱼ+Tputᵢ

Otherwise, job Jᵢ is not scheduled at this step, and the assignment process is blocked until some previously scheduled jobs are completed and the additional resources are released. Accordingly, the longest duration objects are processed first and each next object is considered for the assignment to a storage device with the largest available throughput (e.g., width). Thus, the object is assigned to the storage device with an available DA, the smallest assigned (used) aggregate throughput, and the condition that the assignment of this new job does not violate the storage device throughput maxTput; that is, the current object fits to the available, remaining drive throughput.

When a previously scheduled job Jₖ is completed at the StorageDeviceₘ, the occupied resources are released and the running counters of this storage device are updated as follows:

ActDAⱼ<=ActDAⱼ−1,

StorageDeviceAggTputₘ<=StorageDeviceAggTputₘ−Tputₖ.

Once the counters are updated, the next available object from OrdObjList is tested as to whether it can be assigned to StorageDeviceₘ, and if “yes” then the running counters are updated again, and the backup process continues.

However, some QoS considerations may not be adequately dealt with by implementation of the FlexLBF process. Such QoS considerations can include, for example, a particular time window desired by the client for backup of a set of objects and/or a restore rate desired by the client for a business-critical object among the set of backup objects, which is affected by the number of concurrent DAs used for object backup and which can be determined by reference to empirically-derived data tables.

That is, for backup of business-critical objects there often are additional QoS objectives. Thus, there are additional components in the QoS considerations for backup of business-critical objects that can include the desired rates of the object restore and a limit on and/or a particular time slot for the time window that is to be achieved for a backup session of a given set of objects. The object restore speed can depend on a storage device configuration parameter (e.g., its DA concurrency number) at the backup time of the object. As described herein, the restore rate can denote a rate (e.g., MB/s) and or a time frame (e.g., seconds, minutes, hours, etc.) during which at least one of the objects (e.g., a business-critical program and/or set of data, among other types of objects) is specified to be restored to functionality and/or to availability for access after loss and/or damage resulting in incapacitation thereof. The assigned restore rate can be limited by a cost that increases relative to specification of an increased restore rate. That is, to discourage assignment (e.g., by an administrator) of a high (e.g., fast) restore rate to every object, the higher an assigned restore rate is for an object, the higher the cost incurred can be (e.g., as determined by metrics appropriate to various businesses).

As indicated, there are measured restore rates that can be affected by using different numbers of concurrent DAs. Some of the object's QoS determinants can be defined using these defined classes of concurrent DAs. The present disclosure describes a novel way of addressing these object QoS considerations.

An Enhanced FlexLBF process (e.g., a scheduler) is described herein that provides additional support for satisfying QoS considerations of a job. In order to enable the backup time window desired for a backup session, a simulation module is described herein that advises a system administrator on and/or actively enables backup to a preferred (e.g., low) number of storage devices for a given backup workload. In various examples described in the present disclosure, an Enhanced FlexLBF scheduler (e.g., stored on and/or implemented by hardware, firmware, and/or software, as described herein) can, for example, be used to determine (e.g., to simulate) a low (e.g., lowest) number of storage devices to backup objects.

When planning and scheduling backup sessions, a system administrator may take into consideration the job's QoS requirements, which can include the desirable rates of the object restore, and a backup time window for a backup session of a given set of objects. The object restore speed can depend on the number of concurrent DAs being utilized at the backup time of the object because a higher number of concurrent DAs causes the data streams from these concurrent DAs to be interleaved on the storage device. When the data of a particular object needs to be restored, there is a higher restoration time for retrieving such data compared with, for example, a continuous, non-interleaved data stream written by a single DA.

Measured restore rates correspond to different numbers of concurrent DAs. These restore rates can, for example, be measured using a set of microbenchmarks for these configurations. Achievement of the object's QoS restore rates can be defined using classes of these microbenchmarks. To simplify the notation of QoS restore classes, an explicit DA concurrency per storage device parameter Concᵢ can be assigned that corresponds to the desired restore rate specified in an object's description. Therefore, each object Jᵢ described in the present disclosure is represented by a tuple: (Oᵢ, Durᵢ, Tputᵢ, Concᵢ), where Oᵢ is the name of the object, Durᵢ denotes the backup duration of object Oᵢ observed from the previous full backup, Tputᵢ denotes the throughput of object Oᵢ computed from the previous full backups, and Concᵢ reflects the DA concurrency parameter that corresponds to the restore rates in the object's description. If an object does not have a specifically desired restore rate, then a placeholder value (e.g., ∞) can be used in the QoS specification to mean “best effort”.

The Enhanced FlexLBF process described herein can be generalized to handle the QoS job requirements without an additional inconvenience of partitioning the jobs into different QoS classes for processing by storage devices being configured with a variable DA concurrency number. To achieve this goal in the Enhanced FlexLBF process, an additional control on the DA concurrency number Concᵢ (e.g., determined by at least one object in the set having high criticality as reflected by having restore rate that is shorter than that of other objects in the set) can be directly introduced to, for example, an admission control module of the process. This way, for each object Jᵢ to be scheduled, the process can verify whether there is a storage device with the number of active DAs of an assigned number of DAs that is less than specified by the object's QoS DA concurrency number (e.g., ActDAⱼ<Concᵢ) and whether the job throughput does not exceed the currently available throughput of StorageDeviceⱼ.

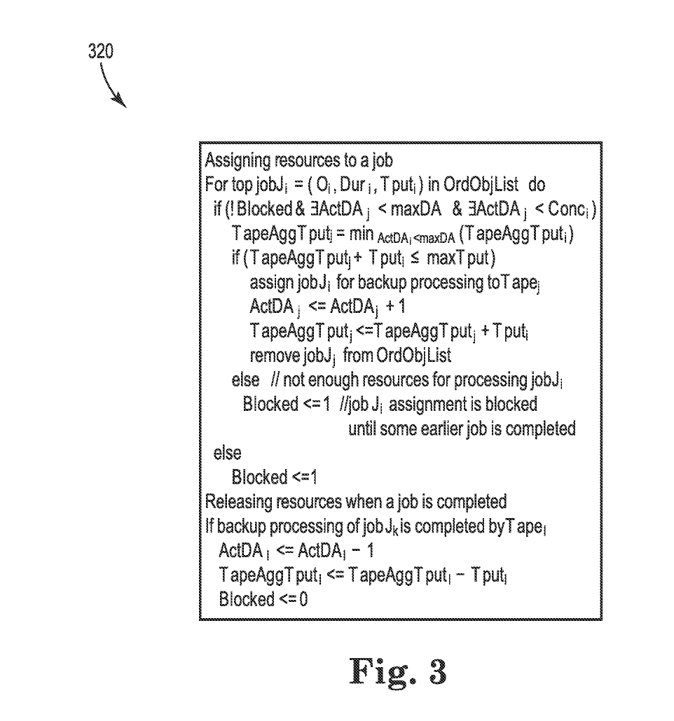

FIG. 3 illustrates an example of pseudo-code for an Enhanced FlexLBF process according to the present disclosure. The Enhanced FlexLBF process described herein accomplishes performance goals for object backup that include reducing the session processing time and fulfilling the individual object's QoS objectives. The pseudo-code 320 shown in FIG. 3 summarizes the Enhanced FlexLBF process.

One QoS objective is achieving backup in a particular backup time window for a backup session of a given set of objects. System administrators may have used a simple rule of thumb when designing and acquiring a backup infrastructure for their work environment. However, accomplishing an object's desired restore rate while maintaining the duration of the backup window for a set of given backup jobs can be a challenging task.

The Enhanced FlexLBF process described herein can, in various examples, utilize a simulation module for system administrators to analyze the potentials of a backup infrastructure and its capacity to satisfy multiple provisioning and resource objectives, for example, how few storage devices can be utilized for processing a given set of backup objects with a specified backup time window?

Such a simulation tool can assist system administrations in satisfying the resource provisioning and capacity sizing objectives for backup services. The system administrator provides the following inputs to the simulator:
a given workload (e.g., a set of objects for backup processing) with historic information on object durations and throughputs as well as the object's QoS desired restore rate;
a backup server configuration with the number of storage devices available in the configuration;
maxTput—an upper (e.g., maximum) throughput value for the storage devices;
Concᵢ—an assigned number of DAs to be used concurrently during backup processing; and
a backup time window T during which the backup service should be performed.

Initially, the simulator can check for solution feasibility (e.g., by determining whether the specified backup window T is equal to or larger than the duration T_{lgst} of the longest backup object in a given set. If T>T_{lgst}, then the solution is feasible. The simulator can then determine the achievable backup processing time Tₛᵢₘ under the Enhanced FlexLBF process with a single storage device (e.g., N=1) and the assigned (e.g., by the administrator and/or by reference to the restore rate table) number of Concᵢ. If Tₛᵢₘ≦T, then the objective is achieved and a given workload can be processed by a single storage device. Otherwise, if Tₛᵢₘ>T then the simulation is repeated with an increased number of storage devices (e.g., N=N+1). The simulation is stopped once the increased number of storage devices leads to an achievable backup processing time within a backup window (e.g., Tₛᵢₘ≦T). The simulator can output both values: N and Tₛᵢₘ. Therefore, a system administrator can use the simulator for understanding the outcomes of many different “what if” scenarios.

A notable difference between the Enhanced FlexLBF process (e.g., with pseudo-code shown in FIG. 3) and the FlexLBF process is with regard to assigning resources to a job (object). The Enhanced FlexLBF process assigns a top job (e.g., the object having the longest previously determined duration) to a particular storage device (e.g., tape) if the number of active DAs is less than the number of DAs assigned to the particular storage device based upon the previously specified restore rate (e.g., the Concᵢ), as indicated by the top three lines of the pseudo-code shown in FIG. 3. In contrast, the FlexLBF process assigns the top job to a particular storage device if the number of active DAs is less than a limit on the upper number of concurrent DAs that can be assigned per storage device (e.g., the maxDA).

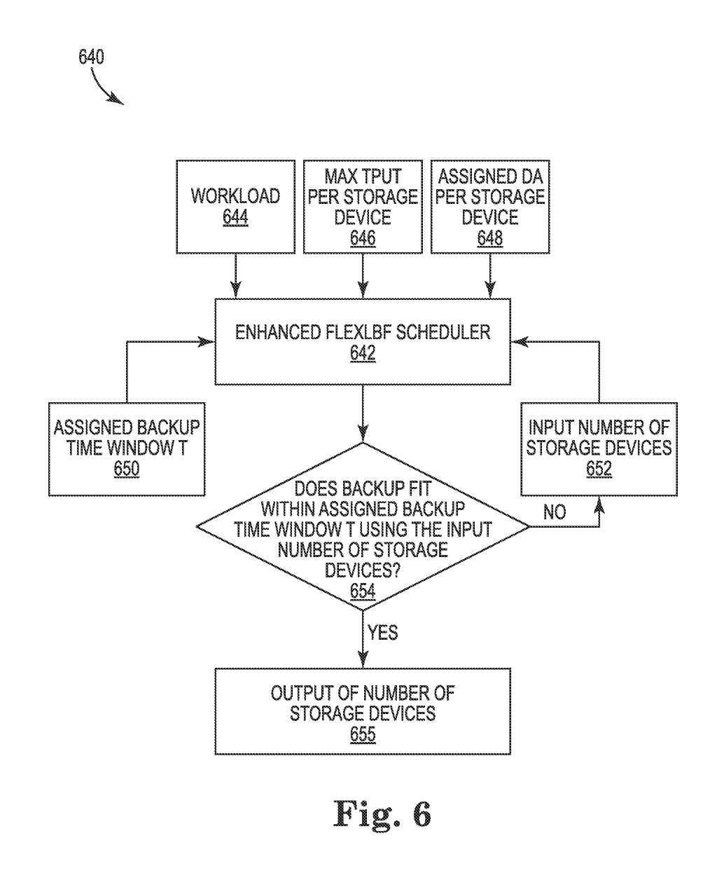

Accordingly, an example of a storage device library (e.g., as shown at 112 in FIG. 1 and at 762 in FIG. 7) that determines a number of storage devices to backup objects can include a plurality of storage devices 110, 768 and a controller 766 to control backup of the objects 102 to an assigned number of the storage devices. The controller determines the assigned number of the storage devices before the backup of the objects based upon assigned parameters for backup of the objects that include a time window (e.g., as shown at 650 in FIG. 6) and a number of concurrent DAs per storage device 108, 648. For example, a simulation (e.g., see FIG. 6) can be repeatedly executed on the storage device library to determine a low (e.g., lowest) number of storage devices to backup the objects within the assigned time window.

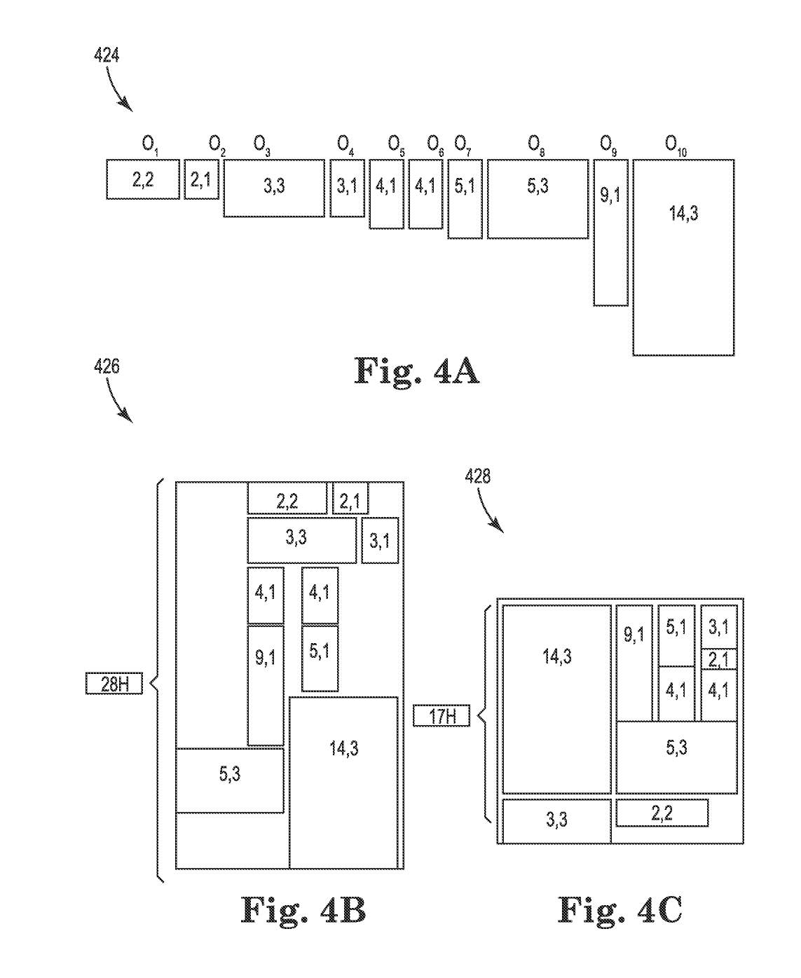

In various examples, the assigned parameters can further include a workload 644 including a defined set (e.g., one or more) of the objects for backup, where each of the objects is associated with an historic value that denotes backup duration (e.g., see FIGS. 2A-2B and 4A-4C) and an historic value that denotes throughput (e.g., see FIGS. 4A-4C). In various examples, the workload can further include at least one of the objects being associated with an assigned restore rate (e.g., as utilized in determining the assigned number of concurrent DAs per storage device 108, 648). The assigned parameters can further include an upper (e.g., maximum) throughput value 646 for the plurality of storage devices (e.g., maxTput).

As described herein, in various examples, the controller 766 can schedule the objects according to a list that backs up an object having a longer previous backup time before an object having a shorter previous backup time (e.g., see FIGS. 2B and 4C), and assigns the objects to disk agents 108, 648 that backup the objects to the storage devices according to the list.

FIGS. 4A-4C illustrate examples of graphs of a backup profiles of objects in a defined set. FIG. 4A illustrates an example of a graph of a number of objects in accordance with the present disclosure. FIG. 4A shows blocks of backup parameters 424 for objects in accordance with the Enhanced FlexLBF process described herein. That is, let there be ten objects O₁, O₂, . . . , O₁₀, in a backup set, and let each object be represented by a tuple: (Durᵢ, TPutᵢ), where these values are as previously described.

FIG. 4B illustrates an example of a graph of a backup profile of the objects in FIG. 4A in accordance with the present disclosure. Let the storage device 426 shown in FIG. 4B have an upper throughput limit of 6 MB/s (e.g., StorageDeviceAggTputⱼ=6) with a Concᵢ of 2 DAs and the TPutᵢ values ranging from 1 MB/s for O₂, O₄-O₇, and O₉ to 3 MB/s for O₃, O₈, and O₁₀. The following example illustrates inefficiency of limitation to this number of DAs in view of the throughput of 6 MB/s of the storage device. If the DAs randomly select the objects for backup utilizing the 2 DAs, the overall backup time for the entire group can be 28 hours, as shown in FIG. 4B, in the single storage device.

FIG. 4C illustrates an example of a graph of a backup profile of the objects in FIG. 4A according to the present disclosure. Let the storage device 428 shown in FIG. 4C have an upper throughput limit of 6 MB/s (e.g., StorageDeviceAggTputⱼ=6) with a Concᵢ of 4 DAs in view of the Enhanced FlexLBF process QoS restore rates and the TPutᵢ values ranging from 1 MB/s for O₂, O₄-O₇, and O₉ to 3 MB/s for O₃, O₈, and O₁₀. Because the longest duration objects are selected for backup first with an aim toward matching, but not exceeding the StorageDeviceAggTputⱼ=6 during the backup session, the Enhanced FlexLBF process can more efficiently backup the defined backup set by efficiently utilizing the throughput and storage capacities of the storage device. That is, the concurrent backup of objects is determined by additive combination of TPutᵢ values for two or more objects being used to prevent overlapping (e.g., concurrent) backup from exceeding the StorageDeviceAggTputⱼ value of 6. For example, the overall backup time for the entire group can be 17 hours, as shown in FIG. 4C, in a single storage device in contrast to the 28 hours shown in FIG. 4B.

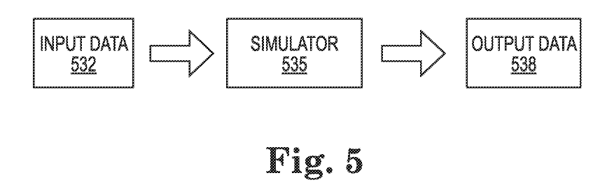

FIG. 5 illustrates an example of inputs and outputs to a simulator according to the present disclosure. FIG. 5 shows a simulator 535, as described herein, that receives input data 532, processes the input data, and provides output data 538. For example, the system administrator can provide one or more of the following inputs 532 to the simulator 535:
a given workload (e.g., the set of objects for backup processing), each of the objects therein having their historic information on object durations and throughputs;
a backup server configuration with the number of storage devices available in the configuration;
maxTput: the upper throughput of the storage device(s),
Concᵢ: the assigned number of DAs to be utilized concurrently during backup processing. This number reflects the criticality of a restore rate of at least one of the objects, which can take into account a level of data interleaving on the storage device(s) that the system administrator is ready to accept; and
a Time Window T during which backup of the set is desired.

Based on the initial inputs 532 from the system administrator, the simulator 535 can produce one or more of the following outputs 538:
a lower number (N) of storage devices capable of processing the given workload within the Time Window T; and
the estimated overall backup time Tₛᵢₘ, which efficiently utilizes the throughput and storage capacities of the storage device(s), as shown with regard to FIG. 4C.

FIG. 6 illustrates an example of a flow diagram to determine a number of storage devices to backup objects according to the present disclosure. The simulation 640 shown in FIG. 6 includes an Enhanced FlexLBF scheduler 642 (e.g., stored on and/or implemented by hardware, firmware, and/or software, as described herein) that receives workload input 644, a maxTput per storage device 646, and an assigned number of DAs (e.g., Concᵢ) per storage device 648. The Enhanced FlexLBF scheduler 642 also stores the assigned backup time window T 650. Further, the Enhanced FlexLBF scheduler 642 receives an input number N of storage devices 652. Utilizing the just presented inputs, the Enhanced FlexLBF scheduler 642 determines a simulated backup processing time Tₛᵢₘ, as described herein. According to block 654, a determination is made as to whether the backup fits within the assigned backup time window T utilizing the input number of storage devices. If the answer to this determination is “no”, then the number of storage devices is increased by a value of 1 (Nᵢ<=Nᵢ+1). This new N value is fed into the Enhanced FlexLBF scheduler 642. If the answer to a determination of either an original input number (e.g., N=1) or a new input number (e.g., N=2) is “yes”, then that particular number of storage devices is usable and is output (e.g., stored) as the number of storage devices 655. The simulation cycle is repeated for estimating the low (e.g., lowest) usable number of storage devices in the system given the input parameters 644, 646, 648, and 650.

Accordingly, in various examples, the present disclosure describes a non-transitory machine readable storage medium having instructions stored thereon to determine a number of storage devices to backup objects. The instructions can be executable (e.g., by a processor) to obtain, from historic data, durations to previously backup to storage devices each of a set of objects (e.g., see FIGS. 2A-2B and 4A-4C). The instructions can be executable to order, based on the durations, each of the set of objects according to a schedule that backs up an object having a longer previous backup duration before an object having a shorter previous backup duration (e.g., see FIGS. 2A-2B and 4A-4C). The instructions can be further executable to increase the number of storage devices to backup the set of objects by changing, during a simulated backup of the set of objects with an assigned number of concurrent DAs per storage device, the number of storage devices until backup of the set of objects fits within an assigned time window (e.g., see FIG. 6 at 652, 654).

The assigned number of concurrent DAs can be determined through an analysis of historic data that includes restore rates based upon use of a range of numbers of concurrent DAs (e.g., groups of 1, 2, 3, . . . , N DAs). That is, a table (e.g., a saved digital table) can be referred to automatically, where the table documents restore rates that resulted from use of the various numbers of DAs, which can indicate a peak number of concurrent DAs beyond which restore rates decline due to data interleaving on the storage devices. As such, the assigned number of DAs can further be determined through a determination of criticality of a restore rate of at least one of the objects in the set of objects.

As described herein, an object can be assigned to one of the number of storage devices if assignment of the object to the one of the number of storage devices does not violate an upper aggregate throughput specified for the one of the number of storage devices. Based upon the considerations just presented, a processor, for example, can determine a low (e.g., lowest) number of storage devices for backup of the set of objects within the assigned time window.

Determining a number of storage devices to backup objects can be performed (e.g., utilizing non-transitory machine readable instructions executed by a processor) by executing (e.g., see FIG. 6) a first simulation to determine a first backup time to backup a number of objects to a first storage device using an assigned number of concurrent DAs and backing up the number of objects to the first storage device when the first backup time Tₛᵢₘ₁ fits within an assigned time window 650. The simulation can continue by executing a second simulation to determine a second backup time Tₛᵢₘ₂ to backup the number of objects to the first storage device and a second storage device using the assigned number of concurrent DAs when the first backup time Tₛᵢₘ₁ does not fit within the assigned time window 650 and backing up the number of objects to the first storage device and the second storage device when the second backup time Tₛᵢₘ₂ fits within the assigned time window 650.

The simulation can further include repeating simulations that increase the number of storage devices for backing up the number of objects until a simulation generates a backup time for the number of objects that fits within the assigned time window. The simulation can further include determining an order for backup that backs up an object having a longer previous backup time before an object having a shorter previous backup time, where the order is further determined by overlapping backup of a plurality of the number of objects such that an additive combination of historic values that denote throughput does not violate an upper aggregate throughput specified for the storage devices (e.g., see FIG. 4C). The order just described can be implemented during actual backup of the objects. Moreover, the simulation can further include determining feasibility of the assigned time window by determining whether an historic value that denotes backup duration of a longest object in the number of objects is shorter than the assigned time window.

FIG. 7 illustrates an example of a storage system according to the present disclosure. FIG. 7 shows a storage system 760 that includes a storage device (e.g., tape) library 762 connected to (e.g., via Ethernet or other suitable connection modalities) an administrative console 763 and a number of host computers 772-1, 772-2 via one or more networks (e.g., via a storage area network (SAN) 770 or other suitable networks). The host computers 772-1, 772-2 can be the client machines 104 shown in FIG. 1 that initially store the data to be backed up by the storage devices shown in FIGS. 1 and 7.

The storage device library 762 can include a management card 764 coupled to a library controller 766 and a number of storage devices 768. The administrative console 763 can, for example, enable a user and/or administrator to select and/or administer backup of data according to the examples described herein. The library controller 766 can be used to execute the functions and/or processes according to the examples described herein.

Businesses cannot afford a risk of data loss. According to Faulkner Information Services, 50% of businesses that lose their data due to disasters go out of business within 24 months, and, according to the US Bureau of Labor, 93% are out of business within five years. The explosion of digital content, along with new compliance and document retention rules, set new requirements for performance efficiency of data protection and archival tools. Current data protection shortcomings and challenges may be exacerbated by continuing double-digit growth rates of data. As a result, IT departments are taking on an ever-greater role in designing and implementing regulatory compliance procedures and systems. However, backup and restore operations still involve many manual steps and processes, thereby being time consuming, and labor intensive. Current systems and processes should be significantly improved and/or automated to timely handle growing volumes of data. Reliable and efficient backup and recovery processing remains an inconvenience for most storage organizations. The estimates are that 60% to 70% of the effort associated with storage management is related to backup/recovery.

A goal of server backup and data restore operations is to ensure that a business can recover from varying degrees of failure, varying from the loss of individual files to a disaster affecting an entire system. During a backup session a predefined set of objects (e.g., client filesystems) should be backed up. However, no information is often available on the expected duration and throughput requirements of different backup jobs. This may lead to inadequate job scheduling that results in increased backup session times and/or object restore times.

To overcome these inefficiencies, among others, the present disclosure characterizes each backup job via a number of metrics, which include job duration, job throughput, an assigned backup time window, and an assigned number of concurrent DAs per storage device. The job duration, job throughput, and assigned number of concurrent DAs metrics are derived from collected historic information about backup jobs during previous backup sessions. The Enhanced FlexLBF process described herein offers backup and restore functionality particularly tailored for enterprise-wide and distributed environments. The Enhanced FlexLBF process can be used in environments ranging from a single system to thousands of client machines on several sites. It supports backup in heterogeneous environments for clients running on UNIX™ and/or Windows™ platforms, among other platforms.

It is to be understood that the above description has been made in an illustrative fashion, and not a restrictive one. Although specific examples for methods, devices, systems, computing devices, and instructions have been illustrated and described herein, other equivalent component arrangements, instructions, and/or device logic can be substituted for the specific examples shown herein. For example, “logic” is an alternative or additional processing resource to execute the actions, functions, etc., described herein, which includes hardware (e.g., various forms of transistor logic, application specific integrated circuits (ASICs), etc.), as opposed to machine executable instructions (e.g., software, firmware, etc.) stored in memory and executable by a processor.

Examples in accordance with the present disclosure can be utilized in a variety of systems, methods, and apparatuses. For illustration, examples are discussed in connection with storage devices, tape drives, a storage device library, and/or a tape library. Examples, however, are applicable to various types of storage systems, such as storage devices using cartridges, hard disk drives, optical disks, and/or movable media, among others. Furthermore, examples of machine readable media and/or instructions disclosed herein can be executed by a processor, a controller, a server, a storage device, and/or a computer, among other types of machines.

As used in the specification and in the claims of the present disclosure, the following words are defined as follows. The term “storage device” means any data storage device capable of storing data including, but not limited to, one or more of a disk array, a disk drive, optical drive, a SCSI device, and/or a fiber channel device. Further, a “disk array” or “array” is a storage system that includes plural disk drives and one or more caches and controllers. Arrays include, but are not limited to, networked attached storage (NAS) arrays, modular SAN arrays, monolithic SAN arrays, utility SAN arrays, and/or storage virtualization.

One or more of the blocks or steps of routines or methods disclosed herein are automated. In other words, the blocks or steps of the routines or methods occur automatically. The terms “automated” or “automatically” (and like variations thereof) mean controlled operation of an apparatus, system, and/or process using computers and/or mechanical/electrical devices without the necessity of human intervention, observation, effort, and/or decision.

The routines and/or methods described herein are provided as examples and should not be construed to limit other examples within the scope of the present disclosure. Further, blocks or steps of routines and/or methods described with regard to different figures can be added to and/or exchanged with the blocks or steps of routines and/or methods described with regard to other figures. Further yet, specific data values (e.g., specific quantities, numbers, categories, etc.) or other specific information should be interpreted as illustrative for discussing examples herein. Such specific information is not provided to limit the examples. Unless explicitly stated, the examples of routines and/or methods described herein are not constrained to a particular order or sequence. Additionally, some of the described examples of routines and/or methods, or elements thereof, can occur or be performed at the same, or substantially the same, point in time.

In various examples, the routines and/or methods described herein, along with data and instructions associated therewith, are stored in respective storage devices, which can be implemented as one or more non-transitory machine readable (e.g., computer readable and/or computer executable) storage media. The storage media include different forms of memory including, but not limited to semiconductor memory devices (e.g., DRAM, SRAM, etc.), Erasable and Programmable Read-Only Memories (EPROMs), Electrically Erasable and Programmable Read-Only Memories (EEPROMs), flash memories, magnetic disks such as fixed, floppy, and/or removable disks, other magnetic media, including tape, and optical media, such as Compact Disks (CDs) and/or Digital Versatile Disks (DVDs). Note that the instructions of the software discussed above can be provided on one machine readable storage medium, or alternatively, can be provided on multiple machine readable storage media distributed in a large system possibly having plural nodes.

What is claimed:

1. A storage device library that determines a number of storage devices to backup objects in view of quality of service considerations, comprising:
a plurality of storage devices; and
a controller to control backup of the objects to an assigned number of the storage devices, wherein the controller determines the assigned number of the storage devices before the backup of the objects based upon assigned parameters for backup of the objects comprising a time window and a number of concurrent disk agents per storage device.

2. The storage device library of claim 1, wherein the assigned parameters comprise a workload and wherein the workload comprises a set of the objects for backup, each of the objects associated with an historic value that denotes backup duration and an historic value that denotes throughput.

3. The storage device library of claim 2, wherein the workload further comprises at least one of the objects being associated with an assigned restore rate.

4. The storage device library of claim 3, wherein the assigned restore rate is limited by a cost that increases relative to an increased restore rate.

5. The storage device library of claim 1, wherein the assigned parameters comprise an upper throughput value for the plurality of storage devices.

6. The storage device library of claim 1, wherein the controller schedules the objects according to a list that backs up an object having a longer previous backup time before an object having a shorter previous backup time, and assigns the objects to disk agents that backup the objects to the storage devices according to the list.

7. A non-transitory machine readable storage medium having instructions stored thereon to determine a number of storage devices to backup objects in view of quality of service considerations, the instructions executable by a processor to:
obtain, from historic data, durations to previously backup to storage devices each of a set of objects;
order, based on the durations, each of the set of objects according to a schedule that backs up an object having a longer previous backup duration before an object having a shorter previous backup duration; and
increase the number of storage devices to backup the set of objects by changing, during a simulated backup of the set of objects with an assigned number of concurrent disk agents per storage device, the number of storage devices until backup of the set of objects fits within an assigned time window.

8. The storage medium of claim 7, wherein the assigned number of concurrent disk agents is determined through an analysis of historic data that comprises restore rates based upon use of a range of numbers of concurrent disk agents.

9. The storage medium of claim 8, wherein the assigned number of disk agents is further determined through a determination of criticality of a restore rate of at least one of the objects in the set of objects.

10. The storage medium of claim 7, wherein an object is assigned to one of the number of storage devices if assignment of the object to the one of the number of storage devices does not violate an upper aggregate throughput specified for the one of the number of storage devices.

11. The storage medium of claim 7, wherein the processor determines a low number of storage devices for backup of the set of objects within the assigned time window.

12. A method for determining a number of storage devices to backup objects in view of quality of service considerations, comprising:
utilizing non-transitory machine readable instructions executed by a processor for:
executing a first simulation to determine a first backup time to backup a number of objects to a first storage device using an assigned number of concurrent disk agents;
backing up the number of objects to the first storage device when the first backup time fits within an assigned time window;
executing a second simulation to determine a second backup time to backup the number of objects to the first storage device and a second storage device using the assigned number of concurrent disk agents when the first backup time does not fit within the assigned time window; and
backing up the number of objects to the first storage device and the second storage device when the second backup time fits within the assigned time window.

13. The method of claim 12, further comprising repeating simulations that increase the number of storage devices for backing up the number of objects until a simulation generates a backup time for the number of objects that fits within the assigned time window.

14. The method of claim 12, comprising determining an order for backup that backs up an object having a longer previous backup time before an object having a shorter previous backup time, wherein the order is further determined by overlapping backup of a plurality of the number of objects such that an additive combination of historic values that denote throughput does not violate an upper aggregate throughput specified for the storage devices.

15. The method of claim 12, comprising determining feasibility of the assigned time window by determining whether an historic value that denotes backup duration of a longest object in the number of objects is shorter than the assigned time window.
